(19) United States
(12) Patent Application Publication
(10) Pub. No.: US 2024/0331188 A1
(43) Pub. Date: Oct. 3, 2024

(54) POSITIONING SYSTEM BASED ON STREET VIEW INFORMATION AND SELF-POSITIONING CORRECTION METHOD

(71) Applicant: OmniEyes Co., Ltd. Taiwan Branch, Taipei City (TW)

(72) Inventors: Chung-Yuan CHEN, Taipei City (TW); Yi-Yen WANG, Taipei City (TW); Chun-Ting CHOU, Taipei City (TW)

(21) Appl. No.: 18/194,101

(22) Filed: Mar. 31, 2023

(51) Int. Cl. G06T 7/70; G06T 17/00; G06V 10/74; G06V 20/58

(52) U.S. Cl. CPC G06T 7/70; G06T 17/00; G06V 10/761; G06V 20/582; G06T 2207/30256; G06V 2201/07

(57) ABSTRACT

A positioning system based on street view information for a vehicle is provided. The positioning system includes a database, an image capturing module and a processing circuit. The database includes information of a plurality of identifiable objects with high discrimination and location information of the plurality of identifiable objects. The image capturing module is disposed on the vehicle and configured to capturing a current image. The processing circuit is configured to determine whether at least one current identifiable object in the current image matches at least one of the plurality of identifiable objects with high discrimination. In response to determining that the at least one currently identifiable object matches at least one first identifiable object of the plurality of identifiable objects, the processing circuit is configured to obtain location information of the at least one first identifiable object for acting as location information of the at least one current identifiable object in the current image and accordingly determine an actual position of the vehicle.

### FIELD OF THE INVENTION

The invention relates to a positioning system based on street view information and a self-positioning correction method, and more particularly, to a positioning system based on street view information and a self-positioning correction method with high efficiency and accuracy positioning.

### BACKGROUND OF THE INVENTION

The global positioning system (GPS) has been widely used in various devices for location purpose. However, when a GPS device is in a signal shadowing environment, such as a tunnel, a jungle or an area susceptible to interference, satellite signals may be blocked and the GPS device is unable to perform the location process in time. Further, in practical application, the GPS device still has the problem of position drift error, which may significantly influence the positioning accuracy. Thus, there is a need for improvement.

### SUMMARY OF THE INVENTION

It is therefore an objective of the present invention to provide a positioning system based on street view information and a self-positioning correction method with high efficiency and accuracy positioning, to solve the problems in the prior art.

The present invention discloses a positioning system based on street view information, applied for a vehicle, comprising: a database, comprising information of a plurality of identifiable objects with high discrimination and location information of the plurality of identifiable objects; an image capturing module, disposed on the vehicle and configured to capture a current image; and a processing circuit, coupled to the image capturing module and configured to determine whether at least one current identifiable object in the current image matches at least one of the plurality of identifiable objects with high discrimination, obtain location information of at least one first identifiable object of the plurality of identifiable objects for acting as location information of the at least one current identifiable object in the current image in response to determining that at least one current identifiable object matches at least one first identifiable object of the plurality of identifiable objects and accordingly determine an actual position of the vehicle.

The present invention further discloses a self-positioning correction method based on street view information, applied for a vehicle, comprising: utilizing an image capturing module disposed on the vehicle to capture a current image; determining whether at least one current identifiable object in the current image matches at least one of the plurality of identifiable objects with high discrimination stored in a database; in response to determining that at least one current identifiable object matches at least one first identifiable object of the plurality of identifiable objects, obtaining location information of at least one first identifiable object of the plurality of identifiable objects for acting as location information of the at least one current identifiable object in the current image and accordingly determining an actual position of the vehicle.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a positioning system with self-positioning correction according to an embodiment of the present invention.

FIG. 2 is a flow diagram of a procedure according to an embodiment of the present invention.

FIG. 3 is a schematic diagram illustrating operations of the positioning system according to an embodiment of the present invention.

### DETAILED DESCRIPTION

It should be understood that both the foregoing general description and the following detailed description are exemplary and explanatory but are not restrictive of the invention as claimed. Certain details of one or more embodiments of the invention are set forth in the description below. Other features or advantages of the present invention will be apparent from the non-exhaustive list of representative examples that follows, and also from the appending claims.

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

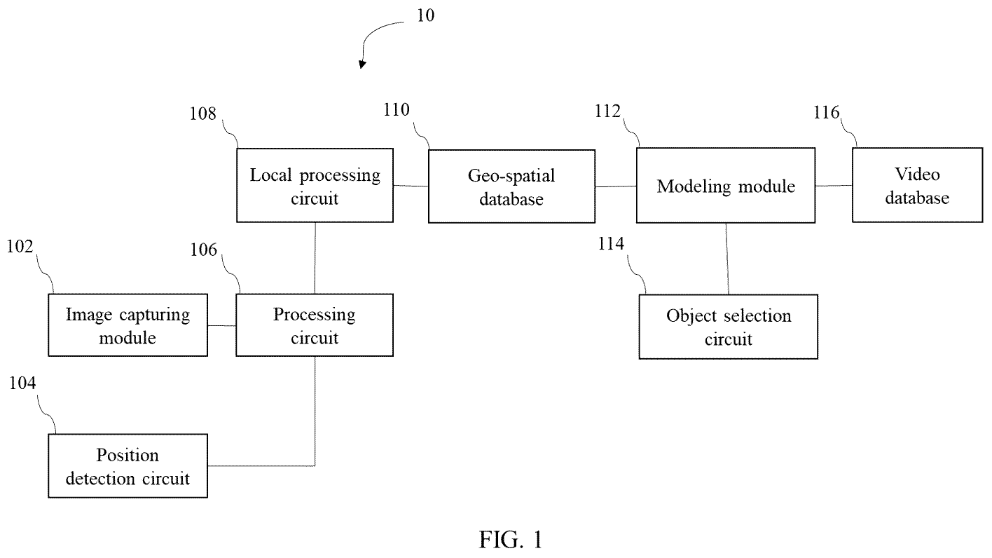

Please refer to FIG. 1, which is a schematic diagram of a positioning system 10 with self-positioning correction according to an embodiment of the present invention. The positioning system 10 of the present invention may be disposed and applied in a target vehicle. The positioning system 10 includes an image capturing module 102, a position detection circuit 104, a processing circuit 106, a local processing circuit 108, a geo-spatial database 110, a modeling module 112, an object selection circuit 114 and a video database 116. The image capturing module 102 is disposed on the target vehicle and configured to capture current images sequentially. The image capturing module 102 may be disposed at any position of the target vehicle, which is capable of capturing images around the vehicle. For example, the image capturing module 102 may be a forward-facing image capturing module for capturing images of a front side of the target vehicle. In an embodiment, the image capturing module 102 may be installed on a windshield of the target vehicle, but not limited thereto. The image capturing module 102 may be a car recorder, a dash cam, a camera, or any other device capable of capturing images. The position detection circuit 104 may be disposed on the target vehicle and configured to detect location information of the target vehicle. The position detection circuit 104 may include a global positioning system (GPS), a Wi-Fi positioning module, a base station positioning module and/or inertial measurement unit (IMU), but not limited thereto.

The geo-spatial database 110 may store information of a plurality of identifiable objects (also called feature points) with high discrimination and high-accuracy location information of the plurality of identifiable objects. The information of the identifiable objects may include data, images and/or image feature data of the identifiable objects. High-accuracy location information of the identifiable objects may include location names and geographic coordinates. The processing circuit 106 is coupled to the image capturing module 102 and the position detection circuit 104, and configured to determine whether there is a current identifiable object in the current image matches unknown identifiable object with high discrimination stored in the geo-spatial database 110, so as to determine the actual position of the current vehicle. The local processing circuit 108 is coupled to the processing circuit 106 and the geo-spatial database 110, and configured to obtain information of identifiable objects with high discrimination and location information of the identifiable objects with high discrimination by querying the geo-spatial database 110 according to requests of the processing circuit 106. The local processing circuit 108 is configured to provide the information of identifiable objects with high discrimination and the location information of the identifiable objects to the processing circuit 106.

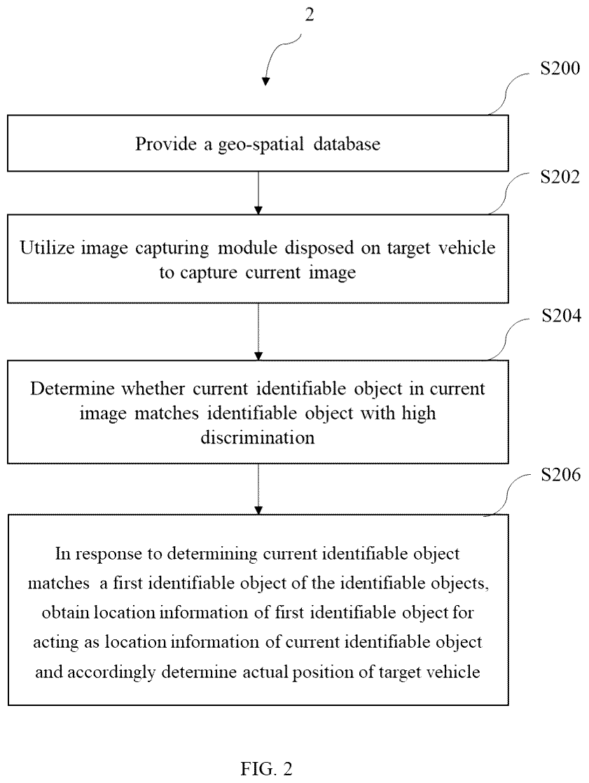

For an illustration of the operations of the positioning system 10, please refer to FIG. 2. FIG. 2 is a flow diagram of a procedure 2 according to an embodiment of the present invention. The flowchart in FIG. 2 mainly corresponds to the operations of the positioning system 10 shown in FIG. 1. The procedure 2 includes the following steps:
Step S200: Establish a geo-spatial database.
Step S202: Utilize the image capturing module disposed on the target vehicle to capture current image.
Step S204: Determine whether current identifiable object in the current image matches identifiable object with high discrimination.
Step S206: In response to determining that at least one current identifiable object matches at least one first identifiable object of the identifiable objects, obtain location information of at least one first identifiable object of the plurality of identifiable objects for acting as location information of the at least one current identifiable object and accordingly determine an actual position of the target vehicle.

According to the procedure 2, in Step S200, the geo-spatial database 110 is established. The geo-spatial database 110 stores information of a plurality of identifiable objects (also called feature points) with high discrimination and high-accuracy location information of the plurality of identifiable objects. The positioning system 10 of the embodiments may predetermine the identifiable objects (or feature points) with high discrimination and high-accuracy location information of the identifiable objects stored in the geospatial database 110 in advance. The embodiments of the invention may collect multimedia video contents provided by previous vehicles, and accordingly calculate and predetermine identifiable objects with high discrimination during an off-line execution phase, such that the determined identifiable objects may be stored into the geo-spatial database 110 for the following. As a result, the target vehicle may real time query information of the plurality of identifiable objects with high discrimination and the corresponding location information stored in the geo-spatial database 10 in the subsequent process during an on-line execution phase.

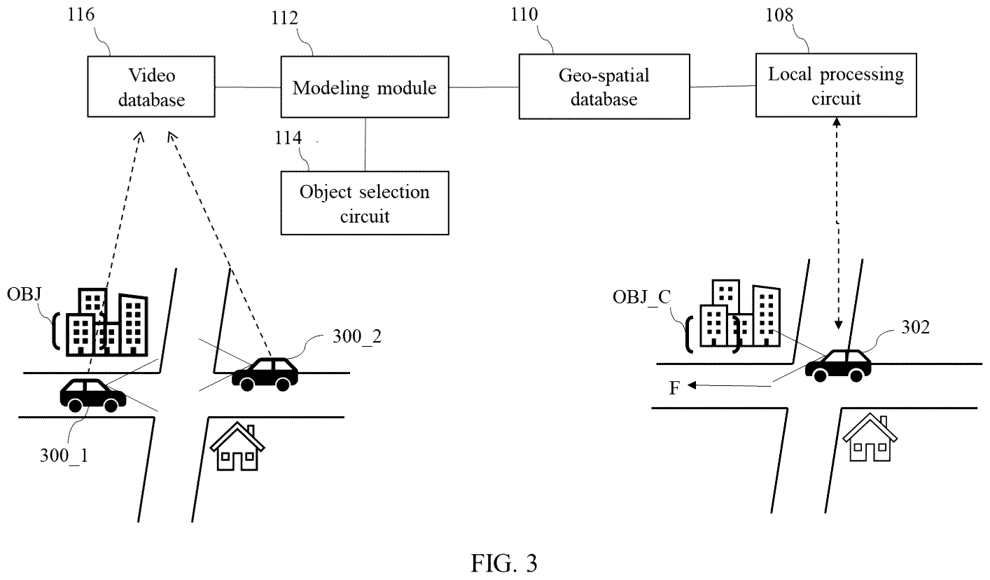

Details of operations of establishing information of the identifiable objects with high discrimination may be shown and described in the following. As the vehicle is equipped with a car recorder (dash cam) and a GPS device, the car recorder and the GPS device may be utilized to capture and record video contents and GPS location information of the surrounding scenes and events on the driving route. The video recorded by the car recorder may include video content and related GPS location information (including latitude and longitude, speed, and bearing (azimuth) measured during the period that the video content is being captured. The video database 116 is configured to collect and store video content files recorded and uploaded by different previous vehicles. The video database 116 may collect video information and location information of a plurality of previous vehicles. For brevity of description, the term “previous vehicle” represents one of the plurality of previous vehicles. The previous vehicle may be a vehicle passing through a space region before a target vehicle travels through the space region and captures the current image. The video information and location information of the previous vehicles stored in the video database 116 may be provided to the modeling module 112. For example, as shown in the bottom left side of FIG. 3, vehicles 300_1 and 300_2 (i.e. previous vehicles) are equipped with driving recorders and GPS devices to capture front images of their vehicles and related location information. When the vehicle 300_1 and the vehicle 300_2 pass through the intersection area, the corresponding videos may be shot and recorded. The videos recorded by the vehicle 300_1 and the vehicle 300_2 may be uploaded to the video database 116. The video database 116 may collect and store video content files of all the previous vehicles passing through the intersection area (e.g., vehicles 300_1 and 300_2).

Moreover, the modeling module 112 is configured to analyze the video of the previous vehicle stored in the video database 116 so as to establish three-dimensional (3D) space models of each space field for subsequent extraction of spatial geometric information and view synthesis. The modeling module 112 may divide the continuous map space into a plurality of finite fields. For example, the geospatial space may be divided into a plurality of key areas. For example, the key areas may include intersections, areas within a radius of 50 meters of intersection, key ramps, and areas that require high accuracy positioning. The modeling module 112 may read the video data uploaded by different previous vehicles and stored in the video database 116. The modeling module 112 may collect and manage the driving record video data of previous vehicles passing through each area. The modeling module 112 may filter out the video data according to conditions of video quality, data integrity and sunshine condition. In this way, each key area has respective videos corresponding to various driving directions and field of views. The modeling module 112 may utilize the video of the previous vehicle stored in the video database 116 to analyze and build a corresponding 3D space model through data mining and machine learning methods. The 3D space model includes 3D space information and view models of each region. The 3D model reconstructs scenes from different perspectives and directions, and integrates different perspectives to create 3D frames for each region. For example, the modeling module 112 may utilize structure from motion (SfM) and radiance field modeling methods to reconstruct a 3D space model according to the video of the previous vehicle stored in the video database 116 for subsequent extraction of spatial geometric information and view synthesis. For example, the modeling module 112 may utilize COLMAP method to create a 3D point cloud model, utilize neural radiance fields (NeRF) method to create spatial field of view information, and utilize Plenoxels algorithm to represent the scene with a sparse 3D grid, so as to establish the 3D space model. The modeling module 112 may utilize the 3D space model to estimate the high-accuracy geographic location of each object and the image frames observed under different viewing angles.

The object selection circuit 114 may identify and select identifiable objects (or feature points) with high discrimination from the 3D space model of each region created by the modeling module 112. In more detail, the object selection circuit 114 may utilize deep neural network technology to extract objects in the 3D space model created by the modeling module 112. The object selection circuit 114 may utilize the object recognition model or feature point model to extract a plurality of objects (or feature points) in each field or key area. The object selection circuit 114 may utilize feature engineering method to calculate discrimination values of the plurality of objects. The discrimination calculation method may include using information of relative strength of information entropy and degree of difference of feature vectors to sort out the objects required for each positioning direction in the field or key area. The sorting results may be stored in the geo-spatial database 110. The directions may include various possible driving directions in the field or key area. The object selection circuit 114 may select multiple objects with higher discrimination values as identifiable objects with high discrimination according to the ranking of the discrimination values. The identifiable objects with high discrimination may include signboard, lane marking, symbol, building feature, optical feature and road, but not limited thereto. The identifiable objects with high discrimination may include objects related to traffic rules and/or driving behavior, such as traffic lights (e.g., traffic signal light), traffic signs (e.g., stop sign), but not limited thereto. The object selection circuit 114 may utilize the 3D space model established by the modeling module 112 to estimate the high-accuracy geographic location information of each identifiable object. The information of the plurality of identifiable objects with high discrimination and the location information corresponding to the plurality of identifiable objects selected by the object selection circuit 114 may be stored into the geospatial database 110 for subsequent query execution. In this way, since the object selection circuit 114 has selected the identifiable objects with high quality and high discrimination by using feature engineering technology, the positioning system 10 applied in the target vehicle may immediately and quickly determine current identifiable objects with high discrimination in the current image when the target vehicle passes through the field or key area.

For example, as shown in the bottom left side of FIG. 3, the modeling module 112 establishes a 3D space model corresponding to the intersection area according to the videos recorded by the previous vehicles (e.g., vehicles 300_1 and 300_2) passing through the intersection area. The object selection circuit 114 extracts a plurality of objects in the intersection area according to the 3D space model corresponding to the intersection area, and selects identifiable objects with high discrimination from the plurality objects by using feature engineering method. For example, a building in the intersection area may be determined as an identifiable object OBJ with high discrimination, and the related information and location information of the identifiable object OBJ may be stored into the geo-spatial database 110.

In Step S200, the local processing circuit 108 may query and obtain information stored in the geo-spatial database 110, and provide the obtained information to the processing circuit 106. For example, after receiving a request from the processing circuit 106, the local processing circuit 108 may query and obtain related information stored in the geo-spatial database 110 so as to provide the related information to the processing circuit 106. The local processing circuit 108, the geo-spatial database 110, the modeling module 112, the object selection circuit 114 and the video database 116 may be disposed on a cloud server. Under such a situation, when the target vehicle has a positioning requirement, the target vehicle may connect to the cloud server and control the local processing circuit 108 to query and obtain data from the geo-spatial database 110. Since the process of establishing identifiable object database may consume a large amount of computing resources and data, the collaborative operations between the modeling module 112, the target object selection circuit 114, the video database 116 and the geospatial database 110 of the embodiments may be performed on a local device or a cloud server during an off-line execution phase. As the driving videos provided by the previous vehicles are processed to determine identifiable objects on the cloud server, the information and location information of the identifiable objects with high discrimination may be stored into the geo-spatial database 110. The embodiments of the invention may be capable of facilitating the target vehicle for locating its own position and angle with high efficiently and accuracy in real time when passing through the target area by using the geo-spatial database 110 storing the information and location information of identifiable objects. The geospatial database 110 may also be disposed on the target vehicle.

In Step S202, the image capturing module 102 disposed on the target vehicle may capture current images. The current images may include images captured by the image capturing module 102 during a first period. For example, when the target vehicle is moving on the road, the image capturing module 102 disposed on the target vehicle may be utilized for capturing the current image. For example, as shown in the bottom right side of FIG. 3, when the user drives a vehicle 302 (i.e., target vehicle) along a traveling direction F and passes through the intersection area, the image capturing module 102 disposed on the vehicle 302 may capture the current images and provide the captured current images to the processing circuit 106.

In Step S204, the processing circuit 106 is configured to obtain the current image from the mage capturing module 102 and determine whether at least one current identifiable object in the current image matches at least one of the plurality of identifiable objects with high discrimination of the geo-spatial database 110. The processing circuit 106 may analyze the current image and accordingly determine at least one object in the current image. The processing circuit 106 may compare the at least one object detected in the current image with the plurality of identifiable objects with high discrimination stored in the geo-spatial database 110 to determine whether at least one object detected in the current image matches at least one of the plurality of identifiable objects with high discrimination of the geo-spatial database 110. When determining that an object detected in the current image matches one of the plurality of identifiable objects with high discrimination of the geo-spatial database 110, the object detected in the current image is determined as a current identifiable object of the current image. Since identifiable objects with high discrimination of the geo-spatial database 110 have been selected through feature engineering method during establishing the geo-spatial database 110, the processing circuit 106 disposed on the target vehicle may be capable of easy, rapidly and efficiently determining the current identifiable objects matching the identifiable objects stored in the geo-spatial database 110 from current image in Step S204, thus achieving high operation without consuming excessive system resources.

In Step S206, for each current identifiable object, the processing circuit 106 may obtain location information of the corresponding first identifiable object for acting as location information of the current identifiable object of the current image and accordingly determine an actual position of the target vehicle. After determining the position information of the current identifiable object in the current image, the processing circuit 106 may perform a camera geometric projection conversion operation on the location information of the current identifiable object in the current image to determine the relative position of the current identifiable object with respect to the target vehicle. As such, the processing circuit 106 may determine the actual position of the target vehicle according to the location information of the at least one current identifiable object in the current image and the relative position of the at least one current identifiable object with respect to the target vehicle. In other words, in Step S206, in response to determining that at least one current identifiable object matches at least one first identifiable object of the plurality of identifiable objects, the processing circuit 106 may obtain location information of the corresponding first identifiable object for acting as location information of the current identifiable object of the current image and accordingly determine the actual position of the target vehicle.

For example, as shown in the bottom right side of FIG. 3, when the user drives the vehicle 302 (i.e., target vehicle) along the traveling direction F and passes through the intersection area, the image capturing module 102 disposed on the vehicle 302 captures the current image and provide the captured current image to the processing circuit 106. The processing circuit 106 analyzes the current image captured by the image capture module 102 and accordingly determines a current identifiable object OBJ_C in the current image. Moreover, the processing circuit 106 obtains object information and location information (e.g., including information of an identifiable object OBJ_C and location information of the identifiable object OBJ_C) of the plurality of identifiable objects stored in the geo-spatial database 110 via the local processing circuit 108. The processing circuit 106 compares the current identifiable object OBJ_C with the plurality of identifiable objects of the geo-spatial database 110, and determines that the current identifiable object OBJ_C detected in the current image matches the identifiable object OBJ of the geo-spatial database 110. Therefore, the processing circuit 106 may obtain location information of the identifiable object OBJ for acting as location information of the current identifiable object OBJ_C of the current image. The processing circuit 106 may perform a camera geometric projection conversion operation on the location information of location information of the current identifiable object OBJ_C of the current image to determine the relative position of the current identifiable object OBJ_C with respect to the target vehicle 302. As such, the processing circuit 106 may determine the actual position of the target vehicle according to the location information of the at least one current identifiable object in the current image and the relative position of the at least one current identifiable object with respect to the target vehicle. For example, when the processing circuit 106 determines that the current identifiable object OBJ_C is located at 5 meters ahead of the right side of the vehicle 302 in the driving direction, the actual position of the target vehicle 302 may be accurately determined according to the location information of the current identifiable object OBJ_C and the relative position information between the current identifiable object OBJ_C and the target vehicle 302.

In other words, the user may utilize the positioning system 10 of the embodiments to locate the current actual position of the vehicle with high accuracy in real time while driving the vehicle. The processing circuit 106 may estimate the actual location of the vehicle by determining that at least one known identifiable object in the geo-spatial database 110 matches at least one of the current identifiable object in the current image captured by the image capturing unit 102. Moreover, although the positioning error of the GPS device may be caused due to the occluded environment or asynchronous clock, the positioning system 10 of the embodiments may still accurately and quickly determine the corresponding position of the current identifiable object in the current image and accordingly determine the current actual position of the target vehicle, thus achieving high-efficiency positioning calculation speed, high-accuracy positioning results and providing users with the best experience.

On the other hand, in order to improve operational efficiency, in Step S204, when the image capturing unit 102 captures the current image, the position detection circuit 104 may be utilized for measuring position information of the target vehicle. The processing circuit 106 may obtain information of at least one identifiable object associated with the location information of the target vehicle from the geo-spatial database 110 according to the location information of the target vehicle measured by the position detection circuit 104. For example, the information of at least one identifiable object associated with the location information of the target vehicle may include an identifiable object adjacent to the location of the target vehicle among the plurality of identifiable objects in the geospatial database 110. For example, the image capturing unit 102 captures the current image, and the position detection circuit 104 measures that the target vehicle is at position P1. The processing circuit 106 may request the local processing circuit 108 to provide information of all identifiable objects with high discrimination near the position P1. Further, the processing circuit 106 analyzes the current image to determine whether there is at least one current identifiable object in the current image matching the aforementioned identifiable objects with high discrimination near the position P1. The processing circuit 106 compares the detected current identifiable objects with at least one of the identifiable objects associated with the location information of the target vehicle. When determining that a current identifiable object matches a first identifiable object of the at least one identifiable object associated with the location information of the target vehicle, the processing circuit 106 obtains the position information of the first identifiable object for acting as the position information of the current identifiable object in the current image and according determines the actual position of the target vehicle. In brief, since the identifiable objects with high discrimination have been screened out by using feature engineering method during establish the geo-spatial database 110, the identifiable object selected based on the position measurement of the position detection circuit 104 may have higher matching possibility. In this way, in Step S204, the processing circuit 106 disposed on the target vehicle may more easily, quickly and efficiently detect the current identifiable object in the current image that matches the identifiable objects stored in the geo-spatial database 110, thus achieving high computing efficiency without consuming additional system resources.

In an embodiment, the local processing circuit 108, the geospatial database 110, the modeling module 112, the object selection circuit 114 and the video database 116 may be disposed in a cloud server. Because the process of establishing identifiable object database may consume a large amount of computing resources and data, the modeling module 112, the object selection circuit 114 and the video database 116 may be utilized to analyze the videos provided by previous vehicles, predetermine information of the identifiable objects with high discrimination and location information of the identifiable objects, and store the information and location information of the identifiable objects with high discrimination to the geo-spatial database 110 during an off-line execution phase. As such, the embodiments of the invention analyze a large amount of data and pre-select identifiable objects with high quality and discrimination through the cloud server in the offline processing execution phase, so as to improve the high-efficiency computing performance of the terminal device in the real-time processing execution and also reduce hardware requirements for the terminal device. Since identifiable objects with high discrimination of the geo-spatial database 110 have been selected through feature engineering method during the off-line execution phase, the target vehicle may connect to the cloud server and control the local processing circuit 108 to query and obtain information of identifiable objects with high discrimination from the geo-spatial database 110 when the target vehicle has a positioning requirement. Under such a situation, the image capturing module 102, the position detection circuit 104 and the processing circuit 106 disposed on the target vehicle may be executed in the on-line execution phase to real time and quickly determine the current identifiable objects matching the identifiable object with high discrimination from the street view image currently captured by the image capturing module 102.

Those skilled in the art should readily make combinations, modifications and/or alterations on the abovementioned description and examples. The abovementioned description, steps, procedures and/or processes including suggested steps can be realized by means that could be hardware, software, firmware (known as a combination of a hardware device and computer instructions and data that reside as read-only software on the hardware device), an electronic system or combination thereof. Examples of hardware can include analog, digital and/or mixed circuits known as microcircuit, microchip, or silicon chip. Examples of the electronic system may include a system on chip (SoC), system in package (SiP), a computer on module (COM), and the positioning system 10. Any of the above-mentioned procedures and examples above may be compiled into program codes or instructions that are stored in a storage device. The storage device may include a computer-readable storage medium. The storage device may include read-only memory (ROM), flash memory, random access memory (RAM), subscriber identity module (SIM), hard disk, floppy diskette, or CD-ROM/DVD-ROM/BD-ROM, but not limited thereto. The processing circuit may read and execute the program codes or the instructions stored in the storage device for realizing the above-mentioned functions. Each of the processing circuit 106, the local processing circuit 108, the modeling module 112, the object selection circuit 114 and the processing circuit may be a central processing unit (CPU), a microprocessor, a digital signal processor (DSP), a programmable controller, a graphics processing unit (GPU), a programmable logic device (PLD), an electronic control unit (ECU) or other similar devices or combination of these devices, but not limited thereto.

To sum up, the embodiments of the invention provide a high efficiency and accuracy positioning system based on street view information. The positioning system 10 of the embodiments of the invention utilizes the image capture module 102 disposed on the target vehicle to capture the street view image, and utilizes the processing circuit 106 to determine the current identifiable objects in the current image matching the known identifiable object of the geo-spatial database 110 to determine the actual location of the target vehicle, such that the fineness and positioning accuracy of the positioning system 10 of the embodiments may be better than the GPS device. Moreover, even the positioning error of the GPS device may be caused by the occluded environment or asynchronous clock, the positioning system 10 of the embodiments may still accurately and quickly determine the corresponding position of the current identifiable object in the current image and accordingly determine the current actual position of the target vehicle, thus achieving high-efficiency positioning calculation speed, high-accuracy positioning results and providing the best experience for the user.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A positioning system based on street view information, applied for a vehicle, comprising:
a database, comprising information of a plurality of identifiable objects with high discrimination and location information of the plurality of identifiable objects;
an image capturing module, disposed on the vehicle and configured to capture a current image; and
a processing circuit, coupled to the image capturing module and configured to determine whether at least one current identifiable object in the current image matches at least one of the plurality of identifiable objects with high discrimination, obtain location information of at least one first identifiable object of the plurality of identifiable objects for acting as location information of the at least one current identifiable object in the current image in response to determining that at least one current identifiable object matches at least one first identifiable object of the plurality of identifiable objects and accordingly determine an actual position of the vehicle.

2. The positioning system of claim 1, wherein the processing circuit analyzes the current image to detect the at least one current identifiable object in the current image and compares the at least one current identifiable object with the plurality of identifiable objects of the database, and for each current identifiable object, when the each current identifiable object matches a first identifiable object of the plurality of identifiable objects, the processing circuit obtains location information of the first identifiable object for acting as location information of the current identifiable object in the current image and determines the actual position of the vehicle according to the location information of the current identifiable object in the current image.

3. The positioning system of claim 1, further comprising:
a position detection circuit, disposed on the vehicle and configured to detect location information of the vehicle;
wherein the processing circuit obtains information of at least one identifiable object associated with the location information of the vehicle from the database according to the location information of the vehicle, for each current identifiable object, the processing circuit analyzes the current image to detect the current identifiable object in the current image and compare the detected current identifiable object with the at least one identifiable object associated with the location information of the vehicle, and when the current identifiable object matches a first identifiable object of the at least one identifiable object associated with the location information of the vehicle, the processing circuit obtains the position information of the first identifiable object for acting as the position information of the current identifiable object in the current image and according determines the actual position of the vehicle.

4. The positioning system of claim 3, wherein the at least one identifiable object associated with the location information of the vehicle comprises an identifiable object of the plurality of identifiable objects adjacent to a location corresponding to the location information of the vehicle.

5. The positioning system of claim 1, wherein the processing circuit performs a projection conversion operation on the location information of the at least one current identifiable object in the current image to determine a relative position of the at least one current identifiable object with respect to the vehicle, and determines the actual position of the vehicle according to the location information of the at least one current identifiable object in the current image and the relative position of the at least one current identifiable object with respect to the vehicle.

6. The positioning system of claim 1, further comprising:
a video database, configured to collect and store videos captured by a plurality of previous vehicles;
a modeling module, coupled to the video database and configured to establish a three-dimensional space model according to the videos captured by the plurality of previous vehicles; and
an object selection circuit, coupled to the modeling module and configured to select the plurality of identifiable objects with high discrimination from the three-dimensional space model.

7. The positioning system of claim 6, wherein the object selection circuit extracts a plurality of objects of the three-dimensional space model, utilizes a feature engineering method to calculate discrimination values of the plurality of objects, and select objects with higher discrimination values among the plurality of objects as the plurality of identifiable objects with high discrimination according to the ranking of the discrimination values.

8. The positioning system of claim 1, wherein the plurality of identifiable objects with high discrimination comprises at least one or a combination of a signboard, a lane marking, a symbol, a building feature, an optical feature, a traffic signal and a road sign.

9. A self-positioning correction method based on street view information, applied for a vehicle, comprising:
utilizing an image capturing module disposed on the vehicle to capture a current image;
determining whether at least one current identifiable object in the current image matches at least one of the plurality of identifiable objects with high discrimination stored in a database;
in response to determining that at least one current identifiable object matches at least one first identifiable object of the plurality of identifiable objects, obtaining location information of at least one first identifiable object of the plurality of identifiable objects for acting as location information of the at least one current identifiable object in the current image and accordingly determining an actual position of the vehicle.

10. The self-positioning correction method of claim 9, wherein the step of determining whether at least one current identifiable object in the current image matches at least one of the plurality of identifiable objects with high discrimination stored in the database comprises:
analyzing the current image to detect the at least one current identifiable object in the current image and comparing the at least one current identifiable object with the plurality of identifiable objects of the database

11. The self-positioning correction method of claim 9, wherein the step of in response to determining that at least one current identifiable object matches at least one first identifiable object of the plurality of identifiable objects, obtaining location information of at least one first identifiable object of the plurality of identifiable objects for acting as location information of the at least one current identifiable object in the current image and accordingly determining an actual position of the vehicle comprises:
for each current identifiable object, when the current identifiable object matches a first identifiable object of the plurality of identifiable objects, obtaining location information of the first identifiable object for acting as location information of the current identifiable object in the current image and determining the actual position of the vehicle according to the location information of the current identifiable object in the current image.

12. The self-positioning correction method of claim 9, further comprising:
detecting location information of the vehicle;
obtaining information of at least one identifiable object associated with the location information of the vehicle from the database according to the location information of the vehicle;
for each current identifiable object, analyzing the current image to detect the current identifiable object in the current image and comparing the detected current identifiable object with the at least one identifiable object associated with the location information of the vehicle; and
when the current identifiable object matches a first identifiable object of the at least one identifiable object associated with the location information of the vehicle, obtaining the position information of the first identifiable object for acting as the position information of the current identifiable object in the current image and according determining the actual position of the vehicle.

13. The self-positioning correction method of claim 12, wherein the at least one identifiable object associated with the location information of the vehicle comprises an identifiable object of the plurality of identifiable objects adjacent to a location corresponding to the location information of the vehicle.

14. The self-positioning correction method of claim 9, further comprising:
performing a projection conversion operation on the location information of the at least one current identifiable object in the current image to determine a relative position of the at least one current identifiable object with respect to the vehicle; and
determining the actual position of the vehicle according to the location information of the at least one current identifiable object in the current image and the relative position of the at least one current identifiable object with respect to the vehicle.

15. The self-positioning correction method of claim 9, further comprising:
collecting and storing videos captured by a plurality of previous vehicles;
establishing a three-dimensional space model according to the videos captured by the plurality of previous vehicles; and
selecting the plurality of identifiable objects with high discrimination from the three-dimensional space model.

16. The self-positioning correction method of claim 15, wherein the step of selecting the plurality of identifiable objects with high discrimination from the three-dimensional space model comprises:
extracting a plurality of objects of the three-dimensional space model;
utilizes a feature engineering method to calculate discrimination values of the plurality of objects; and
selecting objects with higher discrimination values among the plurality of objects as the plurality of identifiable objects with high discrimination according to the ranking of the discrimination values.

17. The self-positioning correction method of claim 9, wherein the plurality of identifiable objects with high discrimination comprises at least one or a combination of a signboard, a lane marking, a symbol, a building feature, an optical feature, a traffic signal and a road sign.
